(19) United States
(12) Patent Application Publication
(10) Pub. No.: US 2013/0159969 A1
(43) Pub. Date: Jun. 20, 2013

(54) DIGITAL SIGNAL PROCESSING WITH LANGUAGE INTEGRATED MONADS

(71) Applicants: Henricus Johannes Maria Meijer, Mercer Island, WA (US); Brian Beckman, Newcastle, WA (US)

(72) Inventors: Henricus Johannes Maria Meijer, Mercer Island, WA (US); Brian Beckman, Newcastle, WA (US)

(73) Assignee: MICROSOFT CORPORATION, Redmond, WA (US)

(21) Appl. No.: 13/328,075

(22) Filed: Dec. 16, 2011

(51) Int. Cl. G06F 9/44

(52) U.S. Cl. 717/116

(57) ABSTRACT

Digital signal processing is facilitated utilizing monads. In other words, a digital signal can be processed as a function of at least one monadic operation over the digital signal. Monadic operations can also be integrated into a general-purpose programming language optionally in a declarative syntax to further facilitate programming with respect to digital signals.

### BACKGROUND

Digital signal processing (DSP) is a pervasive and well-established technology. As the term suggests, DSP concerns the processing of signals by digital means. A signal is variable dependent upon time, space or both and generally provides useful information. For example, a signal can represent audio, video, temperature, pressure, or vibration. Signals can be represented digitally, or in other words by numbers. Processing can involve manipulation of the signal for instance to remove noise, enhance some feature, or separate frequencies. DSP is involved in the fields of acoustics (e.g., speech, audio, sonar, radar . . . ), digital images, communication, seismology (e.g., oil exploration, earthquakes . . . ), and biomedical (e.g., electroencephalogram (EEG), electrocardiogram (EKG)), among others.

The goal of DSP is typically to measure, filter, and/or compress real-world analog signals. To this end, the first step is to convert analog signal to a digital form by sampling utilizing an analog-to-digital converter, which can transform the analog signal into a stream of numbers. Often the output desired is another analog signal. Accordingly, a digital-to-analog converter can be utilized for this purpose. Although signals can be processed in their analog form, processing signals digitally offers many advantages including accuracy and speed provided by error detection and correction as well as data compression.

A variety of computer programming languages and environments can be utilized to process digital signals. These languages and environments can allow developers to experiment with DSP and/or generate programs to run on a dedicated DSP hardware. For example, a developer can experiment with DSP utilizing Octave®, MATLAB®, or Mathematica®, and generate programs utilizing a general-purpose programming language such as C or Java® in combination with specific compilers and libraries, among other things, that support signal processing.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to employment of monads to facilitate digital signal processing. Digital signal processing can be specified and executed based on one or more monadic operations. In one instance, the monadic operations can be integrated into a programming language, such as a general-purpose programming language. Further, a declarative query syntax can be provided to further facilitate programming with respect to digital signals. In one specific, but non-limiting implementation, monadic operations can be embodied as language-integrated query operators that enable data processing to be provided in terms of query specification and execution.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a digital signal processing system.

FIG. 2 is a block diagram of a program structure.

FIG. 3 is a block diagram of a system that facilitated digital signal processing.

FIG. 4 is a flow chart diagram of a method of digital signal processing.

FIG. 5 is a flow chart diagram of a method of processing an expression including at least one monadic operation.

FIG. 6 is a flow chart diagram of a method of interacting with a digital-signal processing store.

FIG. 7 is a schematic block diagram illustrating a suitable operating environment for aspects of the subject disclosure.

### DETAILED DESCRIPTION

Details below are generally directed toward digital signal processing with monads and more particularly language-integrated monads. Digital signal processing is a specific and complicated programming task. Language-integrated monads, or monadic operations, can be employed as a programming model to facilitate digital signal processing. As will be described further herein, monadic operations are generalized functions that are compositional, among other things. Accordingly, monadic operations can be chained together. Moreover, the monadic operations can be integrated within a general-purpose programming language and optionally specified with a declarative syntax to further aid programming. In one instance, monadic operations can be embodied as language-integrated query operators specified as part of a declarative query expression.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

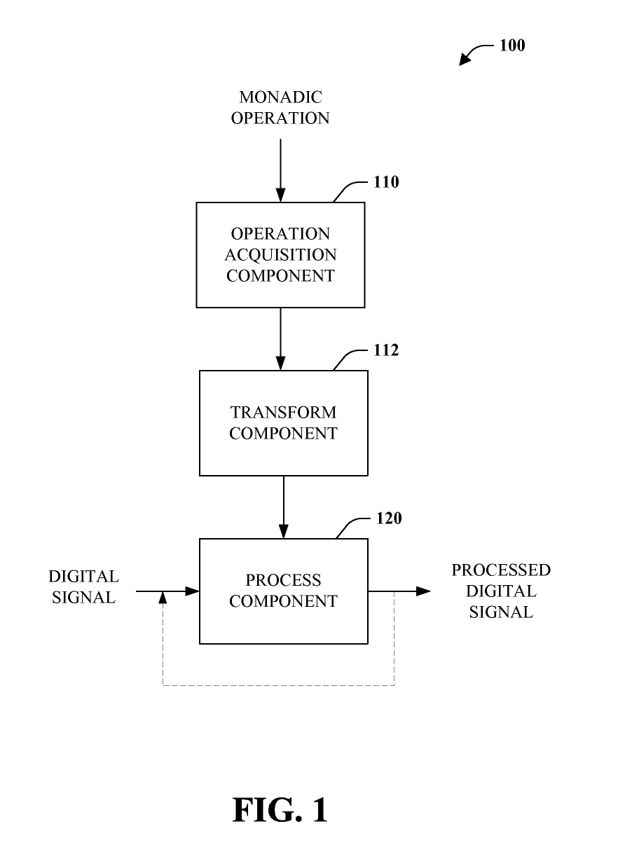

Referring initially to FIG. 1, digital signal processing system 100 is illustrated. The system 100 includes operation acquisition component 110 that is configured to receive, retrieve, or otherwise obtain or acquire one or more monadic operations. A monadic operation, or operator, enables generalized function application and composition. By way of example, consider the follow expression: “(f·g)x=f(g(x)).” Here, “f” and “g” denote two different functions and “x” represents something over which one or more functions can be applied, such as a value or a list. The sub-expression “(f·g) x” symbolizes composition of “f” and “g” applied with respect to “x.” This sub-expression is equal to “f(g(x)),” or application of function “f” to the result of the application of function “g” to “x.”

A so-called “pure” function is a black box that takes input, and computes and returns a result. A pure function cannot perform any side effect including, but not limited to, reading or writing to files or global variables, or throwing or catching exceptions. However, programming solely with pure functions is too limiting, since, in some instances, side effects may be required or using side effects makes a program much easier to write. Monads generalize functions to allow side effects, where desired, while preserving benefits of functional computation including being well behaved (e.g., predictable, less bug prone . . . ), shorter, and compositional, among other things.

A type system (e.g., monadic type system) can be employed to separate side-effecting computations from non-side effecting computations. More formally, a monad has three particular properties:
1. A type construction that for an underlying type defines how to obtain a corresponding monadic type;
2. A unit function that maps a value in an underlying type to a value in the corresponding monadic type; and
3. A binding operation of polymorphic type where a fist argument is a value in a monadic type, a second argument is a function that maps from an underlying type of the first argument to another monadic type and its result is a monadic type
   In practice, a monadic operation can store function results and side effects in a manner that allows side effects to be propagated through return values of functions. For instance, a normal value can be returned or something else such as error value.

Additionally, as provided herein, monadic operations can be incorporated into a programming language such as a general-purpose programming language. In other words, a developer's primary programming language can include support for monadic operations and expressions including one or more monadic operations. Such a programming language can be a non-domain-specific programming language and can include object-oriented programming languages (or languages that support an object-oriented programming paradigm) such as C#®, Visual Basic® or Java®, among others. In one embodiment, monadic operations can be built into a programming language. In another instance, a programming language can be extended by way of extension methods and a library, for example, to support monadic operations. Regardless of implementation, language integration provides, among other things, the ability of a programming environment to perform static type checking as well as provide intelligent programming assistance, for instance, by way of code completion suggestions.

Furthermore, a declarative syntax can be provided to make it easy for monadic operations to be expressed and read. In one implementation, this declarative syntax can be transformed into a native syntax supported by a particular programming language. Consequently, the same or substantially similar programming syntax can be afforded across multiple programming languages. However, employment of the declarative syntax can be optional, and programmers can specify programs with respect to native programming language syntax.

Transform component 112 can be configured to transform a monadic operation or an expression of one or more monadic operations from a first form to a second form. For example, an expression specified with a declarative syntax can be transformed into another form supported by an underlying programming language. Additionally or alternatively, an expression comprising one or more monadic operations can be transformed or translated into another form to facilitate execution. For example, an expression can be saved as data in a data structure (e.g., code as data) that can subsequently supplied or otherwise acquired by the process component 120 and an external service.

The process component 120 is configured to process or in other words execute a monadic operation with respect to a digital signal data, among other things. More specifically, the process component 120 can receive a digital signal and execute a monadic operation over the digital signal to produce a processed digital signal. Here, the digital signal can be the result of application of an analog-to-digital conversion mechanism that discretizes data by sampling, and the processed data signal can be input to digital-to-analog conversion mechanism. Further, since monadic operations are compositional, output of a first monadic operation can be input to a second monadic operation as illustrated by the dashed line in FIG. 1. By way of example, and not limitation, processing can involve any digital signals (e.g., audio, video, image . . . ) and processing including transforms (e.g., Fourier), filtering (e.g., high-pass, low-pass, band-pass . . . ), and convolution, among others.

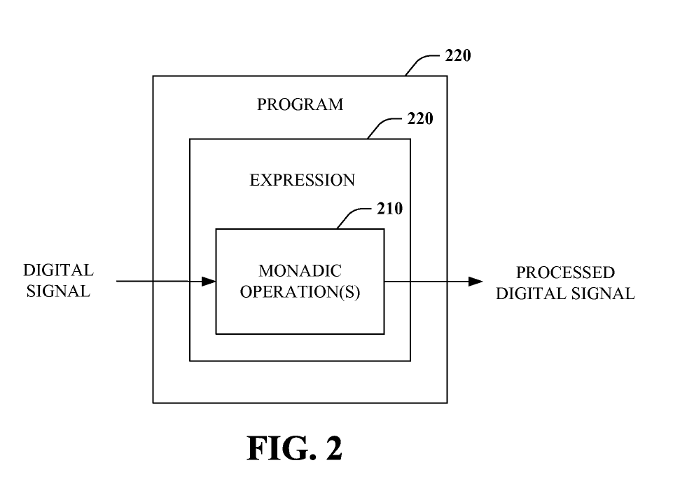

Turning to FIG. 2, a block diagram of a representative program structure is illustrated. A program 210 can be specified in a general-purpose programming language such as, but not limited to, C#®, Visual Basic®, or Java®. The program 210 can include one or more integrated monadic operations 220. Further, the one or more monadic operations can form part of an expression 230 within the program 210. The one or more monadic operations specify functionality with respect to a digital signal and upon execution produce a processed digital signal. For example, one of the one or more monadic operations 220 can be a low-pass filter that removes high spatial frequency noise from a digital image thus smoothing the image.

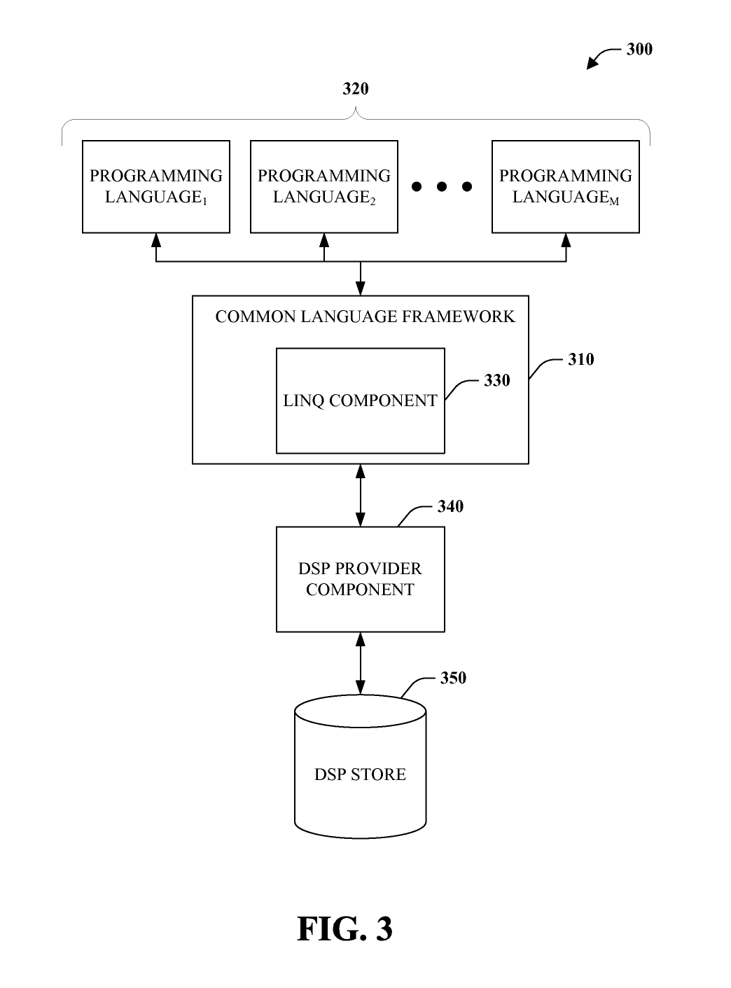

Although not limited thereto system 300 of FIG. 3 depicts one particular embodiment of a digital processing system. As shown, the system includes a common language framework 310, which is a software framework configured to support execution of programs specified in several programming languages 320 (PROGRAMMING LANGUAGE₁-PROGRAMMING LANGUAGE_{M}, where “M” is a positive integer). As part of the aforementioned support, the common language framework 310 provides a library and an execution engine (e.g., common language runtime) that affords an application virtual machine on which programs can be run. Accordingly, language interoperability is supported in which programming languages can use code written in other programming languages. The common language framework can include language integrated query (LINQ) component 330.

LINQ component 330 is configured to provide programming language integrated support for queries. More particularly, the LINQ component 330 is configured to support employment of queries by numerous programming languages 320 that are operable over arbitrary data sources and formats. In accordance with one embodiment, the LINQ component 330 can include a library of query operators that operate over particular data types that are employable through one or the numerous programming languages 320 in coding a program. In one instance, the query operators can be added as extension methods, if they are not already included as part of a programming language. Such query operators can perform various operations over a sequence of data (e.g., push-based or pull-based) including filtering, projection, partitioning, joining, ordering, grouping, and aggregation, among others. Examples of a few query operators are “Select” and “SelectMany” for projection, “Where” for filtering, and “Zip” for combining sequences. Further, a query operator can be a monadic operation/operator.

Additionally, a declarative syntax can be employed to make it easy to write and comprehend queries. More specifically, a declarative shorthand query syntax, such as a SQL (Structured Query Language)-like syntax, can be employed to facilitate specification of queries within a programming language to process digital signal data, as will be described further below. In one implementation, query operators can be provided that map to lower-level language constructs or primitives such as methods and lambda expressions. More specifically, query operators can be mapped to methods that implement the operators that these names represent. In other words, the declarative syntax can be transformed to native method syntax (a.k.a, fluent syntax). For example, consider the following query syntax for acquiring and ordering even numbers in a sequence:

var numQuery1=

from num in numbers

where num % 2==0

orderby num

select num;

The same query can be specified in method syntax, or in other words as a method-based query, as follows:
var numQuery2=numbers.Where(num=>num % 2==0).OrderBy(n=>n).Select(n=>n);
Stated differently, “numQuery1==numQuery2.” Furthermore, query syntax and method syntax are not mutually exclusive, and in some situations, queries can be specified utilizing a different syntax, for example based on the ease of specifying a query or to employ a query operator unavailable in the query syntax. This is ensured since a query expression consists of expressions and expressions have values that other things can operate on. In other words, expressions are composable. Query syntax mostly produces expressions of monadic type, so they are directly and trivially composable with method syntax.

Digital signal processing (DSP) provider component 340 can be configured to facilitate querying a particular digital signal processing (DSP) store 350. In accordance with one embodiment, the LINQ component 330 can generate a data representation of code specifying a query, for example as an expression tree. This data representation can be received, retrieved, or otherwise obtained or acquired by the DSP provider component 340, which can utilize the data representation to construct a semantically equivalent query in a syntax supported by the DSP store 350. Stated slightly differently, the DSP provider component 340 can implement the language integrated query operators over the DSP store 350. Consider, for example, that the DSP store 350 stores image data accessible by way of particular instructions. In this case, the DSP provider component 340 can transform a language-integrated query into instructions supported by the DSP store 350 to acquire and/or transform data as specified by the query. Further, the results can be fed back to a calling program asynchronously. Accordingly, various DSP provider components can form part of the system 300 corresponding to different DSP stores.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, monadic operations can employ such mechanisms to optimize processing of digital signals.

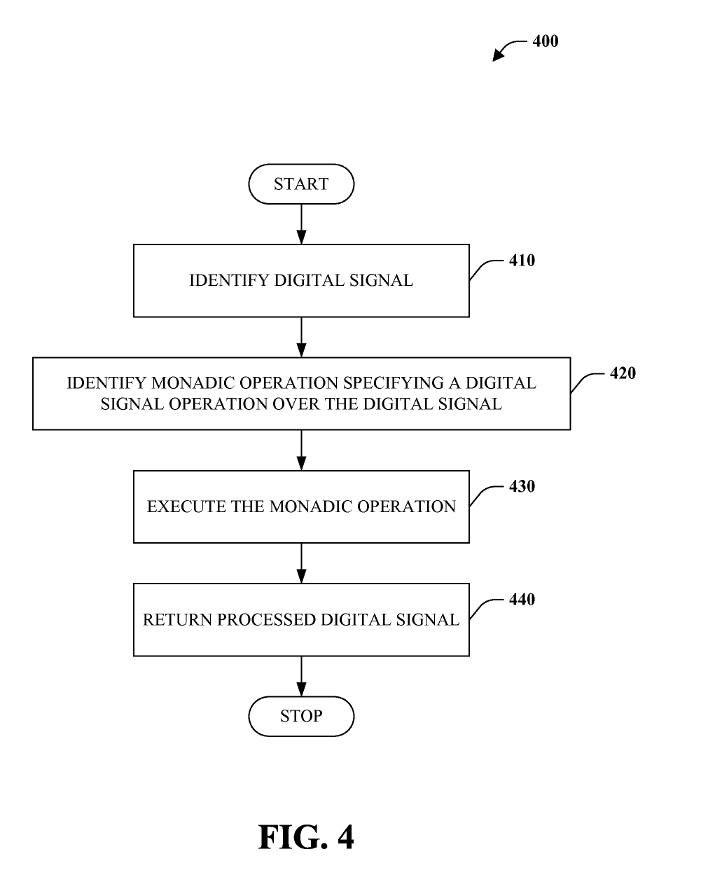

In view of the exemplary systems described supra, methodologies that may be implemented in accordance with the disclosed subject matter will be better appreciated with reference to the flow charts of FIGS. 4-6. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 4, a flow chart diagram of a method 400 of digital signal processing is illustrated. At reference numeral 410, a digital signal is identified. For instance, the digital signal can correspond to a digitized version of an analog signal produced as a result of an analog-to-digital conversion. Such a digital signal can represent an image, audio, or video, for example. At numeral 420, at least one monadic operation is identified with respect to the digital signal, for example as part of an expression. At reference numeral 430, the at least one monadic operation is executed with respect to the digital signal, and at 440 a processed digital signal is returned. For example, a low-pass filter can be specified with a “Where” operator, among others, such that the processed digital signal can correspond to an original signal with a set of high frequencies removed.

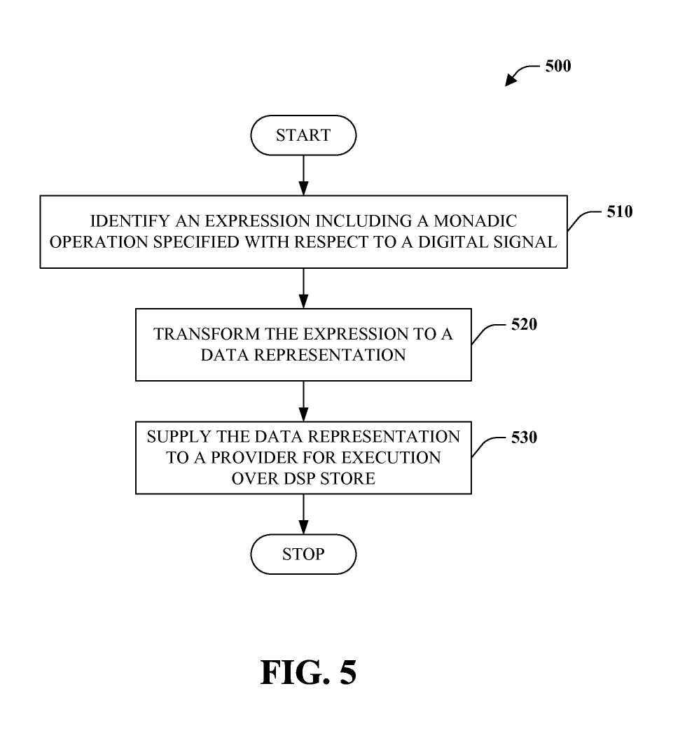

FIG. 5 depicts a method 500 of processing an expression including at least one monadic operation. At reference numeral 510, an expression is identified including at least one monadic operation specified with respect to a digital signal or representation thereof. The expression can be specified in a declarative syntax or alternatively in method syntax, for example. The digital signal can correspond to any audio, video, or image signals, for instance. At numeral 520, the expression can be transformed into a data representation, or structure, such as but not limited to an expression tree. In other words, code is transformed into data. At reference numeral 530, the data representation is supplied, or in other words exposed, to a provider for execution over a particular digital signal processing (DSP) store.

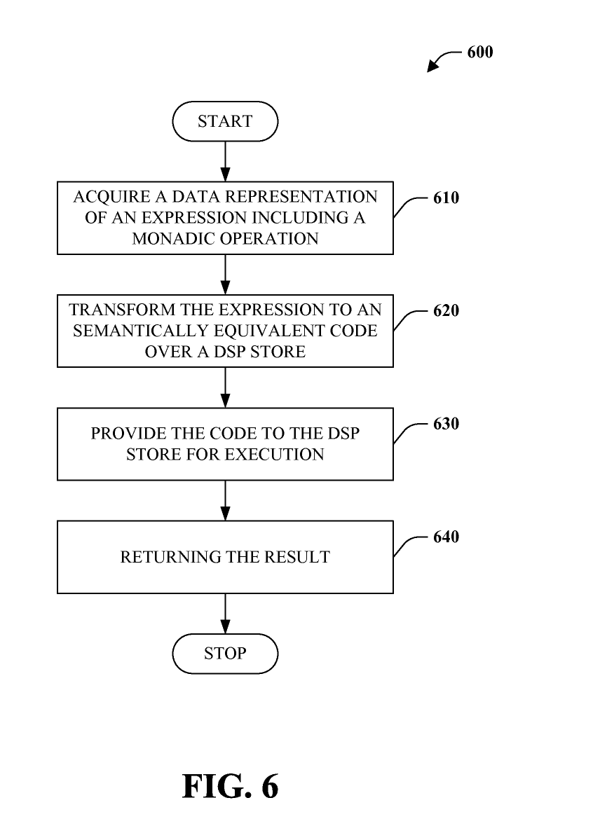

FIG. 6 illustrates a method 600 of interacting with a digital signal processing (DSP) store. At reference numeral 610, a data representation of an expression including at least one monadic operation is received, retrieved, or otherwise obtained or acquired. At numeral 620, the expression is transformed into semantically equivalent code over a DSP store. The code is subsequently provided, at 630, to a DSP store for execution. At reference numeral 640, the result of execution with respect to digital signal data is returned, for example asynchronously to a calling entity.

It can be shown that substantially any digital signal processing (DSP) operation can be specified in terms of a convolution. Hence, a convolution operation can be said to be a primitive digital signal operation. What follows is a detailed example of how a convolution can be specified utilizing monadic query operators integrated within the C#® programming language beginning first with code and discussion regarding performing a change of basis. Furthermore, the included Appendix provides additional information regarding types and methods utilized in the following, inline sample code. Of course, the example and specifics regarding this example are not meant to limit the scope of the claimed subject matter in any manner Rather, the purpose of the example is to aid clarity and understanding with respect to various aspects of this disclosure.

Digital signal processing is performed with respect to a particular basis such as the Fourier basis, wherein a basis is a collection of vectors each expanded in a particular basis that spans a vector space. The following code provides a simple sample vector representative of digital signal data.

var mb = new VS<StandardBasis>(new StandardBasis(3));
mb.Dump(“Standard Basis”);
var sampleVector = new V(new[ ]
{
new Complex(real: 1, imaginary: 0),
new Complex(real: 2, imaginary: 0),
new Complex(real: 3, imaginary: 0)
});

The result is a sample vector in the standard basis comprising three column vectors—“(1, 0), (2, 0), (3, 0).”

A vector is an n-tuple of elements, the standard components, drawn from an underlying algebraic field “F.” For the field, one can think of simply real numbers or complex numbers with a set of commutative and distributive multiplication and addition. Real numbers and complex numbers are typically the only fields of practical importance, but rational numbers sometimes arise. Vectors have additional constraints.

Consider an n-tuple as an array of length “n.” Typically, in a C# program, for example, one would write the i^{th} element of an array “X” as “X[i].” To save space in the following discussion, the i^{th} element of an array “X” is written as “xi.” The lower case indicates that while “X” is an array, elements of the array can be of a different type, namely of type “F.” That is, the elements of the array are members of a field “F.” This notation is utilized solely to shorten the below discussion.

Vectors can form an abelian group (a.k.a. commutative group—wherein operations over group elements is not dependent upon order of the elements) under element-wise vector addition. The following expression defines vector addition, written as an operator “+” between vectors. In terms of a supplied field addition, an overload of the operator “+” can be written between members of a field “F.”

(x1,x2, . . . ,xn)+(y1,y2, . . . ,yn)=def=(x1+y1,x2+y2, . . . ,xn+yn)

All “xi, yi” are in field “F.” Addition inside parentheses like “x1+y1” is addition in field “F.”

Vectors also enjoy linear, distributive scalar multiplication with members of the field. The following expression defines scalar multiplication written as “f X,” with “f” as a member of the field “F” and “X” a vector. In terms of supplied field multiplication operation, written as “f xi,” where both “f” and “xi” are members of the field “F:”

fX=f(x1,x2, . . . ,xn)=def=(fx1,fx2, . . . ,fxn)

Here, “f” and all “xi” are in field “F.” Multiplication outside parentheses is scalar multiplication in the vector space. Multiplication inside the parentheses, like “f xl,” is multiplication in field “F.” “f X=X f”—scalar multiplication inherits commutativity from underlying commutative multiplication in “F.”

The collection of all vectors of a length “n” over the same field “F” under these rules is a vector space of dimension “n.” Members of the field “F” can be called scalars, especially when employed in scalar multiplication as in the above.

A general expression is of the form:

fV+gW+ . . .

In this case, “f, g, . . . ” are in field “F,” and “V, W, . . . ” are vectors in the same vector space over “F.” This is called a linear combination of the vectors “V” and “W.” The scalars, “f, g, . . . ,” can be called coefficients of the linear combination.

In vector space of dimension “n,” it is possible to find a tuple of “n” vectors, “B1, B2, Bn,” with the following properties:
Linear Independence: No Bi is a linear combination of the other “B's” that has at least one non-zero coefficient.
Span: A vector in a vector space can be written uniquely as a linear combination of the “B's.” This particular linear combination of “B's” is called the expansion of “V” in the tuple of “B's.”
   Such a tuple of vectors is called a basis of the vector space, and the coefficients of the expansion of a vector “V” constitute the components of “V” in the basis.

Consider the particular basis whose i^{th} vector has “1” in slot “i” and “0” everywhere else. These vectors can be written as follows and exhibit an clear pattern:

$$\begin{matrix}E 1 = ( 1 , 0 , … , 0 ) \\ E 2 = ( 0 , 1 , … , 0 ) \\ … \\ En = ( 0 , 0 , … , 1 )\end{matrix}$$

Clearly, by application of scalar multiplication and vector addition, any vector “V” with standard components “v1, v2, . . . , vn” equals the following linear combination of the “E's:”

V=v1E1+v2E2++vnEn

The “E's” are called the standard basis and they bear a unique relationship to the standard components of a vector.

Another way of looking at the standard basis is that it is a set of projection operations. Operator “Ei” picks the i^{th} element from the n-tuple that defines the vector via the inner product defined below. Conversely, the n-tuple that defines the vector equals the expansion of the vector in the standard basis.

The standard basis is a reference basis in which to perform calculations with other bases. In one sense, the standard basis is special because it is an available reference. In another sense, the standard basis is just like any other basis. That is, the standard basis is a linearly independent set that spans the vector space. These senses are clarified below.

Consider any two vectors with their standard components “V=(v1, v2, . . . , vn)” and “W=(w1, w2, . . . , wn).” The expression

v1#w1+v2#w2+ . . . +vn#wn

where vi# is the complex conjugate of vi, is the inner product of “V” and “W” in the standard basis. Its geometric interpretation is a scaled projection of vector “V” on vector “W.” Addition and multiplication is in the underlying filed “F,” that is, a scalar, because the field “F” is closed under multiplication and addition in the field. This product is also written with a dot as “V.W.” The inner product enjoys conjugate symmetry, namely

V.W=(W.V)#

The norm of a vector “V” can be defined as the positive square root of its scaled self-projection, namely

|V|=def=Sqrt(V.V)

This number is a member of the real numbers, no matter the field “F.” It turns out that “V . W” can be equated to another expression in terms of the norms of the vectors. That is:

V.W=|V∥W| Cos(angle between V and W)

as a consequence of the so-called Cauchy-Schwarz inequality. The importance of this result becomes apparent later regarding discussion of change of basis. However, note that the following expression is only valid when the v's and w's are standard components.

V.W=v1#w1+v2#w2+ . . . +vn#wn

It should now be apparent that the “Ei,” standard basis vectors, pick the standard components out of factors by way of this standard inner product, namely that

Ei.V=vi for any i between 1 and n, inclusive

and, in particular, that

Ei.Ej=(1, if i=j; else 0)

Shown immediately below is how to compute values of inner products using components in other bases, such that the resulting value is independent of the choice of basis. The value of such a generalized inner product is defined as a scalar invariant of the vector space. That is, it does not depend on a choice of basis, whereas the particular expression above depends on choosing the standard basis.

Using familiar matrix notation, the inner product expression above can be represented as follows:

$$\begin{matrix}V . W . = [ \begin{matrix}v 1 \# & v 2 \# & … & vn \#\end{matrix} ] [ w 1 ] \\ [ w 2 ] \\ [ … ] \\ [ wm ]\end{matrix}$$

That is, with the complex conjugates of the standard components of “V” written as a row vector (with the sense of the work “vector” taken herein the context of linear algebra or matrix algebra) and the standard components of “W” written as a column vector (again the word “vector” in the context of linear algebra or matrix algebra).

This may also be written as “V̂ W” with “̂” meaning “conjugate transpose,” under the implicit convention that vectors from the vector space are written by default as column vectors in the sense of linear algebra or matrix algebra. The expression of conjugate symmetry in matrix notation is:

“V̂W=ŴV)#

Returning to exemplary code, complex composition of vector-space bases can be performed by replacing the basis with the another basis such as the Fourier basis. Such a basis can be specified in method syntax as follows:

var mc = mb.SelectMany<StandardBasis, FourierBasis>(

_standardBasis => { return new

VS<FourierBasis>(new FourierBasis(3)); });

The monadic query operator “SelectMany” implements a monadic bind operation and is employed to perform a change of basis by projecting elements of an input sequence into separate sequences and combining the separate sequences into a single sequence. Here, “SelectMany” takes two parameters “StandardBasis” and “FourierBasis” and employs a function to go from the standard basis to the Fourier basis. The return result is “mc,” which is a variable that encapsulates the Fourier basis in monadic form. Now the previous sample vector can be expanded in the Fourier bases as follows:
DenseVector sampleVectorInFourierBasis=mc.Expand(sampleVector);
The result is the same vector but with different values. Note that result is a linear algebra vector, type “DenseVector,” not a vector-space vector, type “V.” Utilizing a declarative query syntax rather than the method syntax above, the same functionality can be specified as:
mc=from b in new VS<StandardBasis>(new StandardBasis(3))
from c in new VS<StandardBasis>(b)
select new FourierBasis(3);
   sampleVectorInFourierBasis=mc.Expand(sampleVector);

The following provides a detailed description of expansion in a general basis. Consider any basis “B” comprising “n” vectors “B1, B2, . . . , Bn.” By definition, any vector “V” can be written as a linear combination of these vectors. The coefficients of this linear combination can be found as follows. First, write the standard components of the basis vectors as columns of a matrix:

$$[ \begin{matrix}b 11 & b 21 & … & bn 1\end{matrix} ] \\ [ \begin{matrix}b 12 & b 22 & … & bn 2\end{matrix} ] = [ B 1 ] [ B 2 ] [ … ] [ Bn ] = def = [ B ] \\ [ \begin{matrix}\vert & \vert & \backslash & \vert\end{matrix} ] \\ [ \begin{matrix}b 1 n & b 2 n & … & bn n\end{matrix} ]$$

where “[B]ij,” the element in the i^{th} row and the i^{th} column of matrix “[B],” where both “i” and “j” vary from 1 to “n,” inclusive, is “bij,” the i^{th} standard component of the i^{th} basis vector. T

Bi=bi1E1+bi2E2+ . . . +binEn

Here, basis vectors “Bi” are written as column vectors in terms of a linear combination of standard basis vectors “E1” to “En.” Multiplications are scalar multiplications and addition operations are vector additions. Now consider vector “V,” whose standard components are written as a column vector:

$$\begin{matrix}[ v 1 ] \\ [ v 2 ] \\ [ … ] \\ [ v n ]\end{matrix}$$

A column vector of coefficients is now sought:

$$[ vB 1 ] \\ [ vB 2 ] = def = VB \\ [ … ] \\ [ vBn ]$$

such that the “Bi” vectors multiplied by these coefficients and added, sum to the vector “V” (everything written in the standard basis). In matrix notation:

$$\begin{matrix}[ \begin{matrix}b 11 & b 21 & … & bn 1\end{matrix} ] \\ [ \begin{matrix}b 12 & b 22 & … & b n 2\end{matrix} ] \\ [ \begin{matrix}\vert & \vert & \backslash & \vert\end{matrix} ] \\ [ \begin{matrix}b 1 n & b 2 n & … & bnn\end{matrix} ]\end{matrix} \begin{matrix}[ vB 1 ] \\ [ vB 2 ] = [ B ] VB = \\ [ … ] \\ [ vBn ]\end{matrix} \begin{matrix}[ v 1 ] \\ [ v 2 ] \\ [ … ] \\ [ vn ]\end{matrix}$$

The solution is “VB=Inv[B] V,” where “Inv[B] is the matrix inverse of “[B].” The linear independence of the basis vectors ensures that this inverse exists. Since the computation of an inverse can be costly, but large scale-calculations with non-standard bases often desired, a program can allow a user to input an inverse matrix manually.

It has been stated that the column vector, “VB,” of “vBi” coefficients (with “i” varying from 1 through “n,” inclusive, and all “vBi being members of the underlying field “F”) constitutes the components of the vector “V” in the basis “B.” Notices that this is not a vector in the vector space—such a thing can only be represented by its standard components. Rather, it is a column vector in the sense of linear algebra. The distinction between the two can be blurred for many purposes, and the blurring becomes even more tempting in the context of inner products, which have the same form in any basis, including the standard basis.

Returning to the exemplary code and in accordance with the above, matrix multiplication by the invers of the matrix of basis-vectors as columns can be employed to return to the standard basis from the Fourier basis:

var sampleVectorInLinearAlgebra=(mc.MyBasis.B*sampleVectorInFourierBasis)
Alternatively, the inverse Fourier transform can be utilized. Here, one can pretend that the transform is in the standard basis and expand it to the inverse Fourier basis:
var md=from b in new VS<StandardBasis>(new StandardBasis(3))

from c in new VS<StandardBasis>(b)

select new InverseFourierBasis(3);

### md.Expand(new V(sampleVectorinFourierBasis))

The following describes the inner product of two vectors “V” and “W.” In matrix notation, that is “VA W (“A” is the conjugate transpose), which can be written in using rules of “transpose of product=product of transposes in reverse order,” from linear algebra, as

$$\begin{matrix}V \cdot W = V \hat{} W \\ = ( [ B ] VB ) \hat{} W \\ = VB \hat{} [ B ] \hat{} W \\ = ( Inv [ B ] V ) \hat{} [ B ] \hat{} W \\ = V \hat{} ( Inv [ B ] ) \hat{} [ B ] \hat{} W \\ = V \hat{} ( Inv [ B \hat{} ] [ B ] \hat{} ) W \\ = V \hat{} W\end{matrix}$$

Since the conjugate transpose of the inverse is the inverse of the conjugate transpose, allowing the inner product in a basis “B” to be defined as

VBÂ[B]̂[B]WB

Which, since it is equal to “V̂W,” is independent of the choice of basis. Furthermore, since “[B]” for the standard basis is the identity matrix, this definition also pertains to the standard basis, as the inner matrix product evaporates into the identity. The matrix product “[B]̂B” is called the metric tensor of the basis.

The inner product has the same form in any basis including the standard basis. Previously it was noted that the standard basis is special, since the components of the basis vectors of any other basis can be written in terms of their expansion in a the standard basis, so as to “bootstrap” into the other basis. Once bootstrapped, it is realized that the standard basis is just like any other basis when it comes to computing the inner product. The inner product includes substantially all the “directionality” information, or geometric information, that can be extracted from vectors.

With respect to the exemplary code, the inner product of a sample vector with itself can be checked to determine if it is the same as the inner product of the expansions in the Fourier basis. For example:

sampleVector = new V(new[ ]

{

new Complex(real: 1, imaginary:1)
new Complex(real: 2, imaginary: 2),
new Complex(real: 3, imaginary: 3)

});

sampleVector.InnerProduct(sampleVector).Dump(“sampleVector
square norm”);

Here, the result is 28. Now with respect to the Fourier basis:
sampleVectorInFourierBasis=mc.Expand(sampleVector);
var metricTensor=(mc.MyBasis.B.ConjugateTranspose( )*mc.MyBasis.B);
More formally:

(sampleVectorInFourierBasis.Conjugate( )*metricTensor*sampleVectorInFourierBasis).Dump(“sample vector square norm in Fourier Basis”);

Here, the result again is 28.

What follows is exemplary code illustrating employment of monadic operations to perform a convolution with respect to two signals represented as sequences: “as” and “bs.” The signals can be defined as follows:

var n = 100;

var dx = 1d/(n − 1);
var @as = new V(Enumerable.Range(1, n).Select(i => i <= 50 ? 0d :

1d).ToArray( ));

var bsPre = Enumerable.Range(0, n).Select(i =>

{

var x = i*dx;
return x <= 0.5d

? Math.Exp(−100*x*x)
: Math.Exp(−100*(1 − x)*(1 − x));

});

```
  var bTotal = bsPre.Sum( );
  var bs = new V((from b in bsPre select (b/bTotal)).ToArray( ));
```

The convolution can be specified as follows:
var mC=from b in new VS<StandardBasis>(new StandardBasis(100))
from c in new VS<StandardBasis>(b)
select new FourierBasis(100);
   var fAs=mC.Expand(@as);

var fBs=mC.Expand(bs);

var fConvolution=new DenseVector(fAs.Zip(fBs, (x, y)=>

x*y). ToArray( ));

var sqrtN=Math.Sqrt(n);

var convolution=(mC.MyBasis.B * fConvolution)
.Chop( )
.Select(x=>x * sqrtN)
.Dump(“convolution”);
   Note the user of the monadic query operators in both declarative query and method syntaxes, namely “select” and “zip.” The “select” operator provides projection functionality to facilitate a change of basis from the standard basis to the Fourier basis. The “zip” operator provides functionality to stitch sequences together in unique ways. For example, the operator can combine elements of two sequences into a sequence of element pairs. Here, the “zip” operator is used to stitch together “fAs” and “fBs” utilizing point-wise multiplication. This point-wise multiplication is the distinguishing feature of convolution as opposed to some more typical aggregation, for example an inner product. A convolution is not an aggregation in the usual sense of producing a non-monadic output, that is, an element of the underlying type. It is a special operation in the digital-signal processing world. Nonetheless, it is a composable monadic operation.

As used herein, the terms “component,” “system,” and “framework” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

The conjunction “or” as used this description and appended claims in is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A′ employs ‘X,’” “‘A employs ‘Y,’” or “‘A′ employs both ‘A’ and ‘B,’” then “‘A” employs ‘X’ or ‘Y’” is satisfied under any of the foregoing instances.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

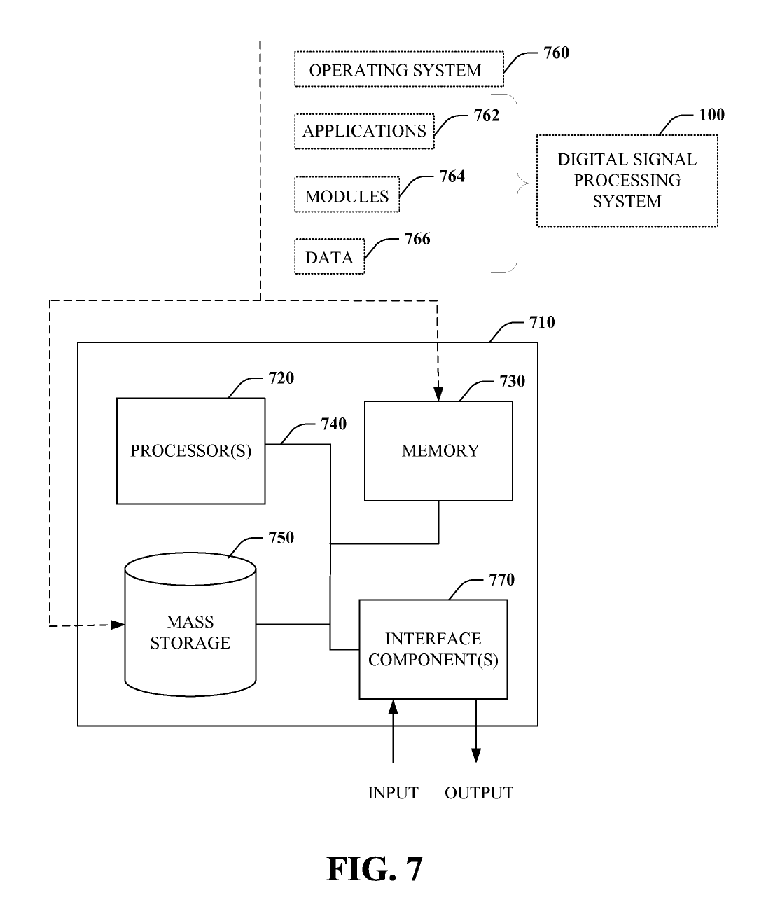

In order to provide a context for the claimed subject matter, FIG. 7 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 7, illustrated is an example general-purpose computer 710 or computing device (e.g., desktop, laptop, server, hand-held, programmable consumer or industrial electronics, set-top box, game system . . . ). The computer 710 includes one or more processor(s) 720, memory 730, system bus 740, mass storage 750, and one or more interface components 770. The system bus 740 communicatively couples at least the above system components. However, it is to be appreciated that in its simplest form the computer 710 can include one or more processors 720 coupled to memory 730 that execute various computer executable actions, instructions, and or components stored in memory 730.

The processor(s) 720 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 720 may also be implemented as a combination of computing devices, for example a combination of a DSP and a microprocessor, a plurality of microprocessors, multi-core processors, one or more microprocessors in conjunction with a DSP core, or any other such configuration. Another embodiment is a graphics processing unit (GPU), which are poser vector-processing machines that can be brought to bear on all kinds of applications.

The computer 710 can include or otherwise interact with a variety of computer-readable media to facilitate control of the computer 710 to implement one or more aspects of the claimed subject matter. The computer-readable media can be any available media that can be accessed by the computer 710 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 710.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 730 and mass storage 750 are examples of computer-readable storage media. Depending on the exact configuration and type of computing device, memory 730 may be volatile (e.g., RAM), non-volatile (e.g., ROM, flash memory . . . ) or some combination of the two. By way of example, the basic input/output system (BIOS), including basic routines to transfer information between elements within the computer 710, such as during start-up, can be stored in nonvolatile memory, while volatile memory can act as external cache memory to facilitate processing by the processor(s) 720, among other things.

Mass storage 750 includes removable/non-removable, volatile/non-volatile computer storage media for storage of large amounts of data relative to the memory 730. For example, mass storage 750 includes, but is not limited to, one or more devices such as a magnetic or optical disk drive, floppy disk drive, flash memory, solid-state drive, or memory stick.

Memory 730 and mass storage 750 can include, or have stored therein, operating system 760, one or more applications 762, one or more program modules 764, and data 766. The operating system 760 acts to control and allocate resources of the computer 710. Applications 762 include one or both of system and application software and can exploit management of resources by the operating system 760 through program modules 764 and data 766 stored in memory 730 and/or mass storage 750 to perform one or more actions. Accordingly, applications 762 can turn a general-purpose computer 710 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the digital signal processing system 100, or portions thereof, can be, or form part, of an application 762, and include one or more modules 764 and data 766 stored in memory and/or mass storage 750 whose functionality can be realized when executed by one or more processor(s) 720.

In accordance with one particular embodiment, the processor(s) 720 can correspond to a system on a chip (SOC) or like architecture including, or in other words integrating, both hardware and software on a single integrated circuit substrate. Here, the processor(s) 720 can include one or more processors as well as memory at least similar to processor(s) 720 and memory 730, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the digital signal processing system 100 and/or associated functionality can be embedded within hardware in a SOC architecture.

The computer 710 also includes one or more interface components 770 that are communicatively coupled to the system bus 740 and facilitate interaction with the computer 710. By way of example, the interface component 770 can be a port (e.g., serial, parallel, PCMCIA, USB, FireWire . . . ) or an interface card (e.g., sound, video . . . ) or the like. In one example implementation, the interface component 770 can be embodied as a user input/output interface to enable a user to enter commands and information into the computer 710 through one or more input devices (e.g., pointing device such as a mouse, trackball, stylus, touch pad, keyboard, microphone, joystick, game pad, satellite dish, scanner, camera, other computer . . . ). In another example implementation, the interface component 770 can be embodied as an output peripheral interface to supply output to displays (e.g., CRT, LCD, plasma . . . ), speakers, printers, and/or other computers, among other things. Still further yet, the interface component 770 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

APPENDIX
public sealed class V
{

public int dim { get; private set; }
public DenseVector ColumnVector { get; private set; }
public V(double[ ] standardComponents)
{

Debug.Assert(standardComponents != null);
Debug.Assert(standardComponents.Length > 0);
this.dim = standardComponents.Length;
this.ColumnVector =

new DenseVector(standardComponents.Select(d => new

Complex(d, 0d)).ToArray( ));

}
public V(Complex[ ] standardComponents)
{

Debug.Assert(standardComponents != null);
Debug.Assert(standardComponents.Length > 0);
this.dim = standardComponents.Length;
this.ColumnVector =

new

DenseVector(((Complex[ ])(standardComponents.Clone( ))));

}
public V(DenseVector standardComponents)
{

Debug.Assert(standardComponents != null);
Debug.Assert(((Complex[ ])standardComponents).Length > 0);
this.dim = ((Complex[ ])standardComponents).Length;
this.ColumnVector =

new

DenseVector((Complex[ ])(((Complex[ ])standardComponents).Clone( )));

}
public Complex InnerProduct(V that)
{

Debug.Assert(that != null);
Debug.Assert(this.dim == that.dim);
var left = this.ColumnVector.Conjugate( );
var right = that.ColumnVector;
var product = left*right;
return product;

}
public Complex Sum( )
{

return this.ColumnVector.Sum( );

}
public V Select(Func<Complex, Complex> f)
{

return new V(this.ColumnVector.Select(f).ToArray( ));

}

}
public static class Extensions
{

public static Complex Sum(this IEnumerable<Complex> that)
{

| | |
|---|---|
| return that.Aggregate(Complex.Zero, | (x, y) => x + y); |

}
public static double Chop(this double that)
{

return Math.Abs(that) < 1e−13 ? 0 : that;

}
public static Complex Chop(this Complex that)
{

return new Complex(that.Real.Chop( ),

that.Imaginary.Chop( ));

}
public static V Chop(this V that)
{

return new V(that.ColumnVector.Select(c =>

c.Chop( )).ToArray( ));

}
public static Complex[ ] Chop(this Complex[ ] that)
{

return that.Select(c => c.Chop( )).ToArray( );

}
public static

MathNet.Numerics.LinearAlgebra.Generic.Matrix<Complex> Chop(

this MathNet.Numerics.LinearAlgebra.Generic.Matrix<Complex>

that)

{

var d = new DenseMatrix(that.RowCount, that.ColumnCount);
for(var i = 0; i < that.RowCount; i++)

for (var j = 0; j < that.ColumnCount; j++)

d[i,j] = that[i,j].Chop( );

return d;

}
public static DenseMatrix Chop(this DenseMatrix that)
{

return new DenseMatrix(

that.RowCount,
that.ColumnCount,
that.Data.Chop( ));

}
public static DenseVector Chop(this DenseVector that)
{

return new DenseVector(((Complex[ ])that)

.Select(c => c.Chop( )).ToArray( ));

}
public static DenseVector Select(this DenseVector that,

Func<Complex, Complex> f)

{

return new

DenseVector(((Complex[ ])that).Select(f).ToArray( ));

}

}
BASIS
// A basis is a collection of n vectors, each EXPANDED IN THE STANDARD
// BASIS, that span the vector space, meaning that any vector is
// expressible as a linear combination of the basis vectors.
public abstract class Basis
{

public int dim { get; protected set; }
// The components of ANY basis vector are expanded in the
// STANDARD basis. This is the standard “communication protocol”
// underlying all bases.
public V[ ] Vectors { get; protected set; }
// The matrix whose COLUMNS are the basis vectors of the basis.
public DenseMatrix B { get; protected set; }
public DenseMatrix InvB { get; protected set; }
public Basis(int dim)
{

this.dim = dim;
Vectors = new V[this.dim];
B = new DenseMatrix(dim);
//InvB = new DenseMatrix(dim);
for (int row = 0; row < this.dim; row++)
{

Vectors[row] = new V(new Complex[this.dim]);

}

}
public abstract DenseVector Expand(V vector);

}
STANDARD BASIS
public sealed class StandardBasis : Basis
{

private void InitStandardBasis(int dimension)
{

InvB = new DenseMatrix(dim);
for (int row = 0; row < dimension; row++)

for (int col = 0; col < dimension; col++)

InvB[row, col] =
B[row, col] =
Vectors[row].ColumnVector[col] =

row == col ?
Complex.One :
Complex.Zero;

}
public override DenseVector Expand(V vector)
{

return new DenseVector(vector.ColumnVector);

}
public StandardBasis(int dim = 3) : base(dim)
{

InitStandardBasis(dim);

}

}
FOURIER BASIS
public sealed class FourierBasis : Basis
{

private Complex phi(int j, int k)
{

double s = 1D / Math.Sqrt(this.dim);
return s * (Complex.Exp(

new Complex(

real: 0,
imaginary: − j * k * 2 * Math.PI /

this.dim)));

}
private void InitFourierBasis(int dimension)
{

for (int row = 0; row < dimension; row++)

for (int col = 0; col < dimension; col++)

B[row, col] =
Vectors[row].ColumnVector[col] = phi(row,

col);

// Expensive
// A constructor can be employed in which user inputs the

inverse manually

InvB = (DenseMatrix)((new UserLU(B)).Inverse( ));

}
public FourierBasis(int dim = 3) : base(dim)
{

InitFourierBasis(dim);

}
public override DenseVector Expand(V vector)
{

Debug.Assert(vector != null);
Debug.Assert(vector.dim == dim);
return InvB * vector.ColumnVector;

}

}
public sealed class InverseFourierBasis : Basis
{

private Complex phi(int j, int k)
{

double s = 1D / Math.Sqrt(this.dim);
return s * (Complex.Exp(

new Complex(

real: 0,
imaginary: j * k * 2 * Math.PI /

this.dim)));

}
private void InitInverseFourierBasis(int dimension)
{

for (int row = 0; row < dimension; row++)

for (int col = 0; col < dimension; col++)

B[row, col] =
Vectors[row].ColumnVector[col] = phi(row,

col);

// EXPENSIVE
// Constructor can be employed that allows in which user

inputs the inverse manually

InvB = (DenseMatrix)((new UserLU(B)).Inverse( ));

}
public InverseFourierBasis(int dim = 3) : base(dim)
{

InitInverseFourierBasis(dim);

}
public override DenseVector Expand(V vector)
{

Debug.Assert(vector != null);
Debug.Assert(vector.dim == dim);
return InvB * vector.ColumnVector;

}

}
VECTOR SPACE
public sealed class VS<B> where B : Basis
{

// This is the basis “contained” in the instance of the monad
public B MyBasis { get; private set; }
// This constructor is the *implementation* of the monadic
// “Return” operator:
public VS(B basis) { this.MyBasis = basis; }
// Just forward the request to the basis
public DenseVector Expand(V vector)
{

return MyBasis.Expand(vector);

}

}
VECTOR SPACE MONAD
// A monad has two operators: Return and Bind.
public static class VectorSpaceExtensions
{

// Here is the monadic “Return” that lifts a basis into a vector
// space.
public static VS<B> Return<B>(B basis)

where B : Basis { return new VS<B>(basis); }

// This is the monadic “bind”.
public static VS<C> SelectMany<B, C>(this VS<B> mb, Func<B, VS<C>>

f)

where B : Basis
where C : Basis { return f(mb.MyBasis); }

// The following “generalized” SelectMany is used to satisfy C#
// code-gen, but it's not needed for the correct monadic
// definition of Vector Space
public static VS<C> SelectMany<B, C>(this VS<B> mb, Func<B, VS<B>>

f, Func<B, B, C> g)

where B : Basis
where C : Basis

{

// This generalized SelectMany calls the ordinary

SelectMany

// above and the ordinary Select below:
return mb.SelectMany(x => f(x).Select(y => g(x, y)));

}
// Need the following Select (map) to build up the “generalized”
// SelectMany
public static VS<C> Select<B, C>(this VS<B> mb, Func<B, C> b2c)

where B : Basis
where C : Basis { return Return(b2c(mb.MyBasis)); }

}

What is claimed is:

1. A method of digital signal processing, comprising:
employing at least one processor configured to execute computer-executable instructions stored in memory to perform the following acts:
processing a digital signal as a function of at least one monadic operation specified over digital signal data.

2. The method of claim 1 further comprises acquiring the at least one monadic operation from a program coded in a programming language that supports an object-oriented programming paradigm.

3. The method of claim 2 further comprises acquiring the at least one monadic operation from the program specified in a method syntax.

4. The method of claim 2 further comprises acquiring the at least one monadic operation from the program specified in a declarative query syntax.

5. The method of claim 2, processing the digital signal comprises performing a change of basis based on a monadic operation that produces sequences for elements of an input sequence and combines the sequences to produce a single output sequence.

6. The method of claim 2, processing the digital signal comprises performing a convolution based at least on a monadic operation that combines two sequences.

7. The method of claim 1 further comprises saving the monadic operation as data in a data structure.

8. The method of claim 1, processing the digital signal comprises performing a change of basis based on a monadic bind operation.

9. The method of claim 8, processing the digital signal comprises performing a change of basis to a Fourier basis or from a Fourier basis.

10. A system that facilitates digital signal processing, comprising:
a processor coupled to a memory, the processor configured to execute the following computer-executable components stored in the memory:
a first component configured to process a digital signal based on at least one monadic query operator integrated within a general-purpose programming language.

11. The system of claim 10, the first component is configured to process the digital signal based on a declarative query-expression syntax comprising the at least one query operator.

12. The system of claim 10, the query operator is specified in method syntax.

13. The system of claim 10, the at least one query operator projects elements of an input sequence into separate sequences and combines the separate sequences into a single sequence.

14. The system of claim 10, the at least one query operator filters elements of a sequence.

15. The system of claim 10, the at least one query operator combines elements of two sequences into a sequence of element pairs.

16. The system of claim 10, further comprises a second component configured to transform an expression comprising the at least one query operator into a data representation.

17. The system of claim 10, the at least one query operator includes “select” and “where” that specify a filter.

18. A computer-readable storage medium having instructions stored thereon that enables at least one processor to perform the following acts:
executing a first monadic operation specified in a general-purpose programming language over digital signal data; and
returning a result.

19. The computer-readable storage medium of claim 18, further comprising executing a second monadic operation over the result of the first monadic operation.

20. The computer-readable storage medium of claim 18, executing a query expression comprising the first monadic operation.
